(19) United States
(12) Patent Application Publication
(10) Pub. No.: US 2016/0350511 A1
(43) Pub. Date: Dec. 1, 2016

(54) Method of Improving Patient Medication Compliance

(71) Applicant: Elliot Roger Franz, Elkins Park, PA (US)

(72) Inventor: Elliot Roger Franz, Elkins Park, PA (US)

(21) Appl. No.: 15/167,661

(22) Filed: May 27, 2016

Related U.S. Application Data
(60) Provisional application No. 62/167,081, filed on May 27, 2015.

(51) Int. Cl. G06F 19/00

(52) U.S. Cl. CPC G06F 19/3456; G06F 19/322

(57) ABSTRACT

A method of improving compliance between a patient and a care provider is implemented by an electronic alert device, where the electronic alert device is programmed and managed by the care provider. The patient is given the electronic alert device upon consultation so that the electronic alert device is able to notify the patient about a daily dosage time of prescribed medication. The electronic alert device visually and audibly notifies the patient about the dosage time with a color-coded notification to accurately identify the correct medication as the color of the medicine container corresponds to the color of the notification. Once the patient inputs a user response into the electronic alert device indicating whether the prescribed medication is taken or not, the electronic alert device timestamps and records the user response to be accessed by the care provider.

The current application claims a priority to the U.S. Provisional Patent application Ser. No. 62/167,081 filed on May 27, 2015.

### FIELD OF THE INVENTION

The present invention relates generally to a patient medication compliance system. More specifically, the present invention is a patient medication compliance system composed of a graphical user interface visible to the care provider and an electronic reminder/data storage system which is used by the patient.

### BACKGROUND OF THE INVENTION

The issue of medication non-compliance is an important field of research in many areas of healthcare (not only optometric practice). In fact, on average, one third of patients have been reported to be non-compliant with medication regiments. There are many negative outcomes associated with non-compliance, including adverse effects, secondary medical problems, dissatisfaction, frustration, and the wasting of health resources. Resultantly, it is desirable to increase healthcare compliance. The relationship between a healthcare practitioner and a patient, the role of clinic and staff, and most importantly the patient's medication compliance once they have left the care facility, are some areas which can be addressed to improve healthcare compliance.

The practitioner-patient relationship is critical in improving healthcare compliance. This can be divided in several facets which are to be addressed. One, a practitioner can learn to instill confidence in a patient, which is enhanced by continuity of the practitioner-patient relationship. Second, regular appointments between a patient and a practitioner (for example in eye care) help to establish a rapport and are to be encouraged. Third, practitioners should assume that all patients are potentially non-compliant, and work to individualize recommendations specific to the different needs of different patients. During regular checkups, the practitioner should ask the patient about the latter's compliance between the previous visit and the current visit. Finally, it should be noted that a patient's actual behavior may differ from their reported behavior. In short, patients may provide inaccurate reports of their own compliance.

On the clinic side, staff can work to improve patient satisfaction, which correspondingly may affect compliant behavior of the patient. Staff of a clinic should also directly encourage compliance, as well as make use of any available devices which can aid with improving compliance. Additionally, beyond direct involvement of staff, posters within a clinic should advocate the use of compliance technology as well as emphasize the importance of compliance.

To further improve compliance, all communications and education regarding healthcare compliance should be clearly written in plain language (avoiding the use of jargon) with accompanying illustrations. The education supports advice given to patients and encourages improved compliance.

In light of the above, it is an objective of the present invention to determine the most effective (i.e. best solution and lowest cost) way to minimize non-compliance in healthcare patients, with focus being given to optometry and ophthalmology. Popular approaches for minimizing non-compliance currently include patient portals, mobile messaging, and check-in screening. As an example of the latter, a tablet such as an iPad can be provided at check-in, which is used to prompt the patient to answer a question about their normal practices.

Home monitoring devices, including commonly elaborate designs utilizing nearfield communications (e.g. Bluetooth and WiFi) with pill caps, remind patients to take medicine as prescribed. For example, a sleep monitoring app for sleep apnea patients could be provided as software. Simpler “low tech” reminders, such as magnets, Post-it notes, and pillboxes are alternative solutions that remain effective. However, both the above examples are “open-loop” systems; this means that they do not introduce any level of accountability for the patient. A Post-it note, for example, is easily ignored. Better solutions include closed-loop systems and direct patient monitoring. However, while more effective than open-loop systems, closed-loop systems have a high cost and are sometimes not financially feasible.

The solution implemented by the present invention is a closed-loop system that seeks to minimize cost while still retaining the advantages of a closed-loop system. This is done in part by taking into account daily routines of a patient. The present invention utilizes continuity of the practitioner-patient relationship to help improve compliance. The economics of the present invention follows a ‘razor/blade’ model, in which practice owners make a one-time purchase of software followed by small purchases of the compliance hardware for distribution to patients.

The present invention provides a closed-loop solution by using an electronic alert device to monitor patient compliance. The electronic alert device periodically alerts the patient about daily dosage time until the patient pushes a button on the device (e.g., “Yes”, “No”, or Snooze”), indicating that medicine has been taken or not. The device records the corresponding patient response (i.e., the button push) indicating when the medicine is taken or not. This recorded data is made available to the practitioner upon the patient's return to the facility. The data is used by the practitioner to verify that the patient indeed took their medicine as well as to perform advance analytics, such as population management. For example, the practitioner will say something like “is this a true representation of when you took your medicine?” This confrontation by the doctor combined with the data generated by the patient will encourage them to be honest about their compliance and subsequently improve their compliance for the next visit. In this manner, the present invention results in improved healthcare compliance by of the individual patient and better care of all patients through data analysis, graphical representation of compliance, and population management.

### BRIEF DESCRIPTION OF THE DRAWINGS

FIG. 1 is a basic network diagram illustrating the overall interaction of the present invention.

FIG. 2 is a basic flow chart illustrating the overall process of the present invention.

FIG. 3 is a basic flow chart illustrating the audible notification within the overall process of the present invention.

FIG. 4 is a basic flow chart illustrating the illumination of LED within the overall process of the present invention.

FIG. 5 is a basic flow chart illustrating the activation of the yes button within the overall process of the present invention.

FIG. 6 is a basic flow chart illustrating the activation of the no button within the overall process of the present invention.

FIG. 7 is a basic flow chart illustrating the activation of neither the yes button nor no button within the overall process of the present invention.

FIG. 8 is a basic flow chart illustrating the retrieving the event times and the user response within the overall process of the present invention.

### DETAIL DESCRIPTIONS OF THE INVENTION

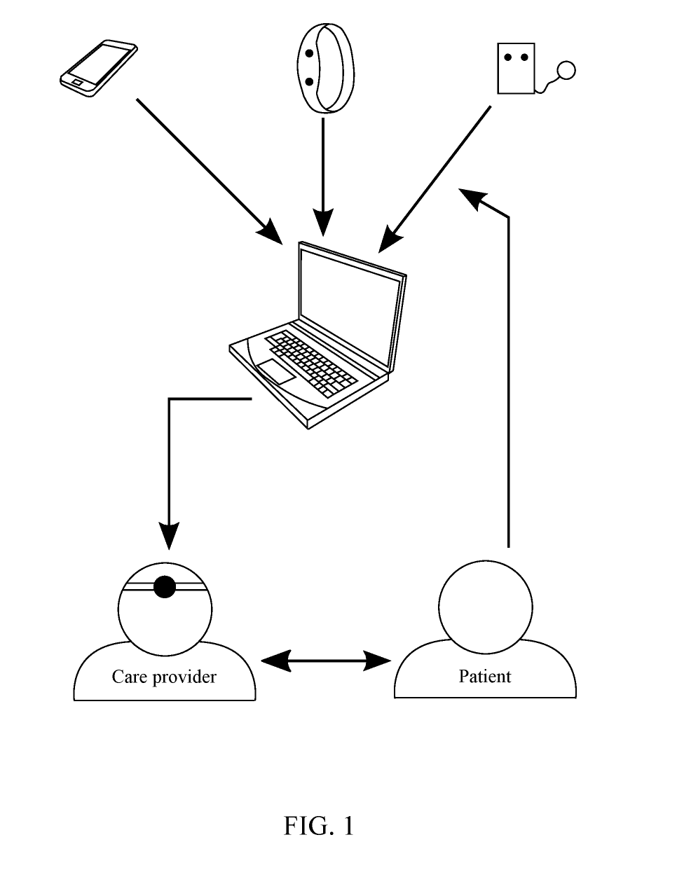

All illustrations of the drawings are for the purpose of describing selected versions of the present invention and are not intended to limit the scope of the present invention. The present invention is an improved patient compliance system that takes place in between a patient and a care provider. The present invention is implemented through an electronic alert device that visually and audibly notifies/reminds the patient to take their medication in relation to a recommended daily intake. In reference to FIG. 1, the electronic alert device is assigned to the patient by their care provider in order to alert the patient about his or her recommended daily medication intake. Additionally, the electronic alert device also functions as a digital logbook so that the patient is able to keep track of their medicine intake and the corresponding time of each medicine intakes. The electronic alert device can be implemented through a variety of apparatus including, but not limited to, wristbands, keychains, necklaces, belt buckles, and pendants. In the preferred embodiment, the patient is referred to herein after as a patient account and the care provider as a care provider account.

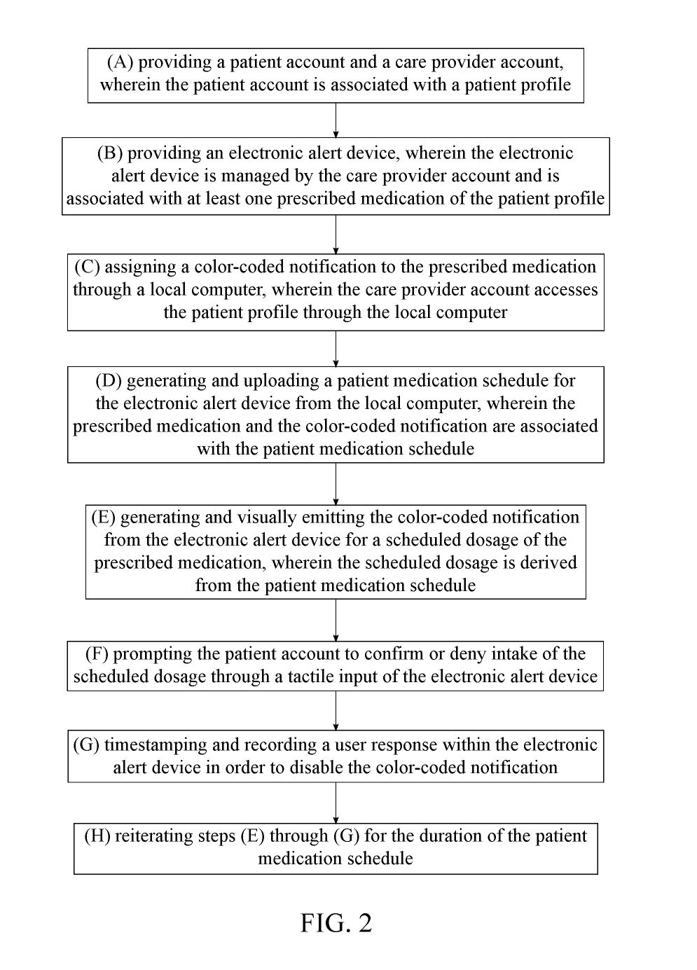

In reference to FIG. 2, a patient profile is associated with the patient account and includes identification information and at least one prescribed medication. The electronic alert device is programed and managed by the care provider account and associated with the prescribed medication of the patient profile. This allows the care provider account to monitor the medication intake with respect to the patient account. More specifically, since the care provider account is able to access the patient profile through a local computer of the care provider account, the prescribed medication of the patient profile can be viewed through the local computer. As a result, the care provider account is able to assign a color-coded notification to the prescribed medication of the patient profile through the local computer as the first step. The color-coded notification is utilized within the present invention so that the patient account can clearly identify the correct medication container as the color of the medication container also corresponds to the respective color of the color-coded notification. The care provider account then generates a patient medication schedule for the electronic alert device through the local computer so that the patient medication schedule can be linked with the prescribed medication and the color-coded notification. If the patient account has multiple prescribed medications, each prescribed medication is assigned with different color-coded notifications in order to accurately notify the patient account which medication to taken at a given time interval. For example, if the patient account has two different prescribed medications, the first medication is assigned with a red color notification as the color-coded notification and the second medication is assigned with a blue color notification as the color-coded notification. Once the patient medication schedule is generated, the care provider account uploads the patient medication schedule for the electronic alert device from the local computer. More specifically, a universal serial bus (USB) port of the electronic alert device enables the local computer to upload the patient medication schedule. The patient medication schedule and the color-coded notification are then stored within a chipset of the electronic alert device as the color-coded notification is required necessary for upcoming steps of the present invention. Optionally, the present invention can also upload a detailed light system for the prescribed medication that has tapering dosage after a specific period of time. For example, if a specific medication has three pill, two pill, and one pill dosage requirements over a three-day time period, each exact dosage requirement can be represented with three consecutive color-coded notifications, two consecutive color-coded notifications, and a single color-coded notification respectively. Once the electronic alert device is initially programmed by the care provider account, the electronic alert device is given to the patient to wear or keep with them until their next visit.

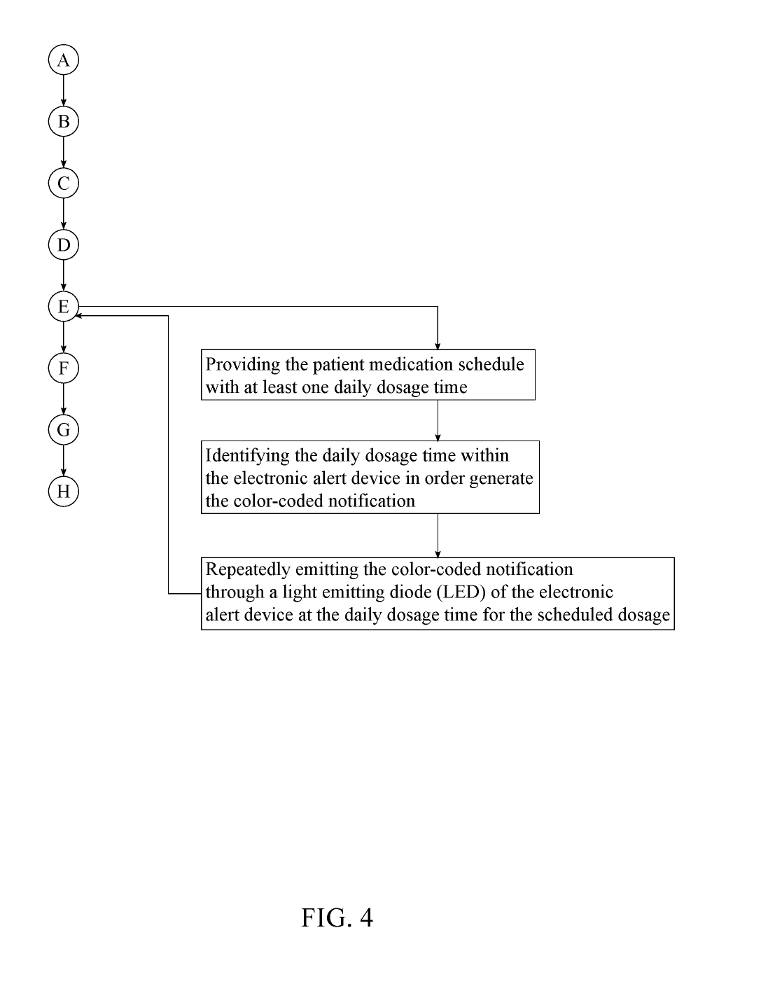

In reference to FIG. 2 and FIG. 4, the present invention then generates and visually emits the color-coded notification from the electronic alert device so that the patient account can be reminded about a scheduled dosage of the prescribed medication based on the patient medication schedule. More specifically, the patient medication schedule includes at least one daily dosage time that periodically identifies the recommended daily intake. The electronic alert device identifies the daily dosage time with respect to an internal clock of the electronic alert device in order to generate the color-coded notification. Once the daily dosage time is recognized within the chipset of the electronic alert device, the chipset then generates the color-coded notification. As a result, a light emitting diode (LED) of the electronic alert device is able to visually and repeatedly convey the color-coded notification to the patient account. The LED functions as a visual indicator within the present invention so that the patient account can be reminded about the daily dosage time of the scheduled dosage. Additionally, when the patient account has multiple prescribed medications, the LED is illuminated with the respective color of each medication container. As a result, the patient account can easy identify the correct scheduled dosage that relates to the specific daily dosage time.

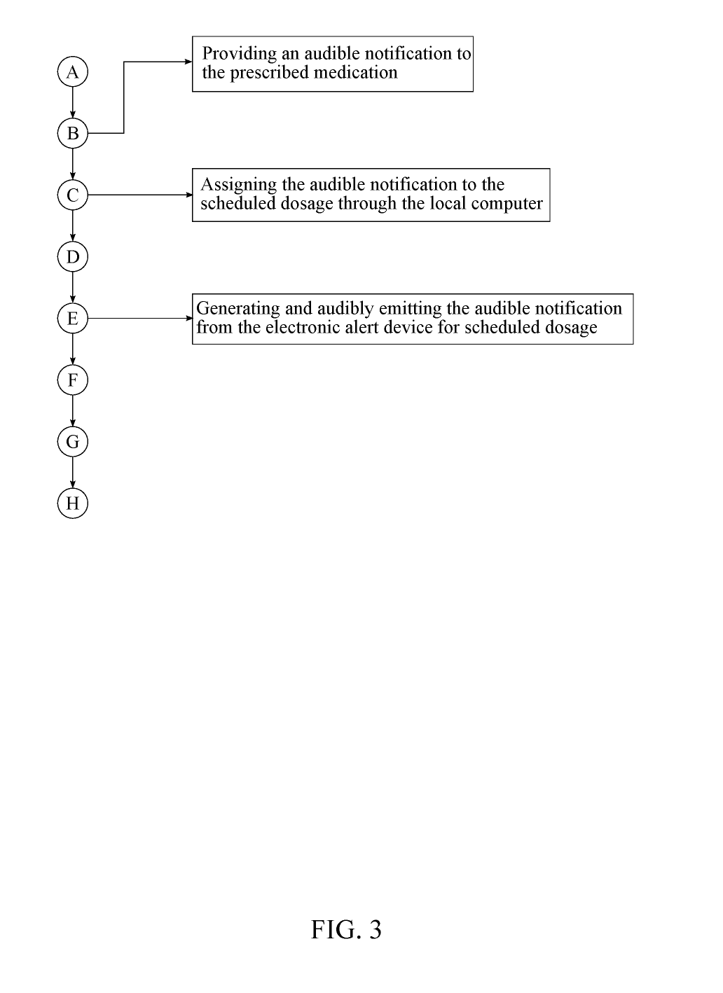

Additionally, the present invention can also utilize an audible notification for the prescribed medication in addition to the color-coded notification as shown in FIG. 1 and FIG. 3. Similar to the color-coded notification, the audible notification is also assigned to the prescribed medication of the patient profile through the local computer. Then, the audible notification can also be generated and audibly emitted from the electronic alert device along with the color-coded notification. As a result, the audible notification is able to alert the patient account about the scheduled dosage.

Once the color-coded notification is emitted through the LED, the present invention then prompts the patient account to confirm or deny intake of the scheduled dosage through a tactile input of the electronic alert device. Since the color-coded notification repeatedly emits by the LED, the electronic alert device is able to successfully alert the patient account about the daily dosage time. The present invention is able to document the intake of the scheduled dosage through the electronic alert device. For example, the patient account is instructed by the care provider account to push a yes button of the electronic alert device if the patient account has taken the scheduled dosage or push a no button of the electronic alert device if the patient account has not taken the scheduled dosage. More specifically, the yes button and the no button within the electronic alert device functions as the tactile input of the present invention so that the patient account is able to correctly respond for the scheduled dosage. If the yes button or the no button is not pushed, the electronic alert device repeatedly emits the color-coded notification for a pre-defined time period. For example, the pre-defined time period can be a specific number of hours, days, or until it is time for the next daily dosage time. There is also a snooze button within the electronic alert device that delays the medication alert for a short amount of time. Once the electronic alert device receives a user response within the pre-defined time period or after the pre-defined time period, the electronic alert device timestamps and records the user response so that the color-coded notification and the audible notification can be silenced within the electronic alert device.

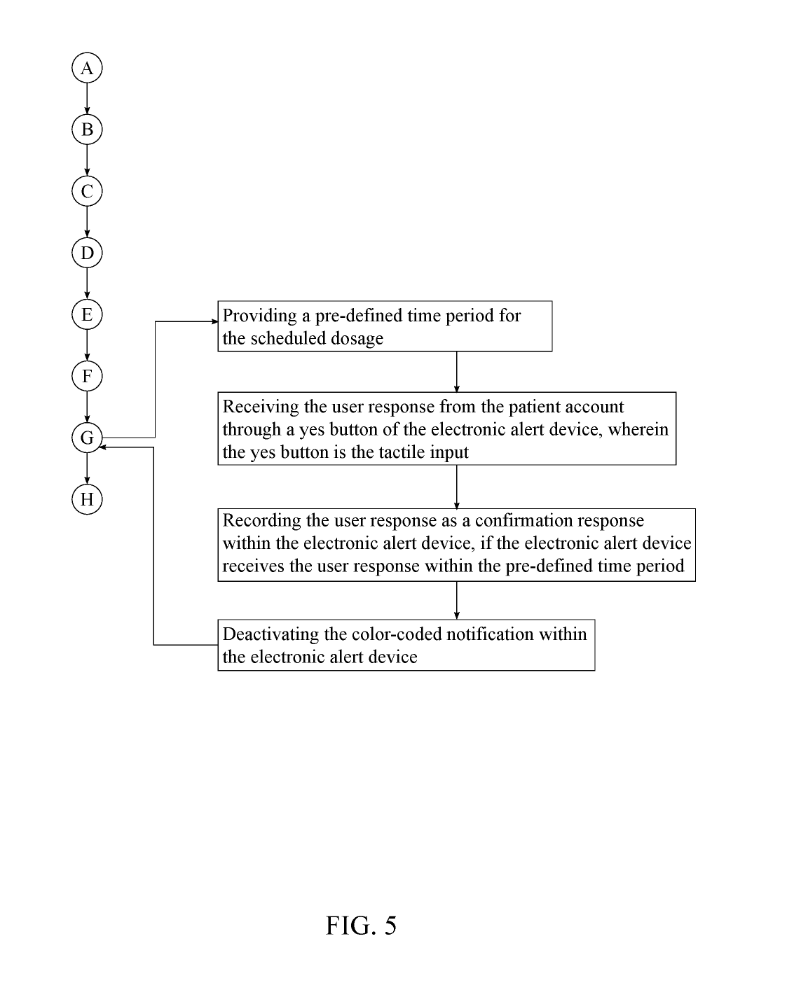

In reference to FIG. 1 and FIG. 5, when scheduled dosage is taken by the patient account, the patient account is supposed to push the yes button to disable the color-coded notification. More specifically, when the chipset detects the yes button activation as the user response within the electronic alert device, the chipset records the user response as a confirmation response within the present invention if the confirmation response is received within the pre-defined time period. The chipset then deactivates the color-coded notification within the electronic alert device. Additionally, the chipset also timestamps an event time and the confirmation response within the electronic alert device.

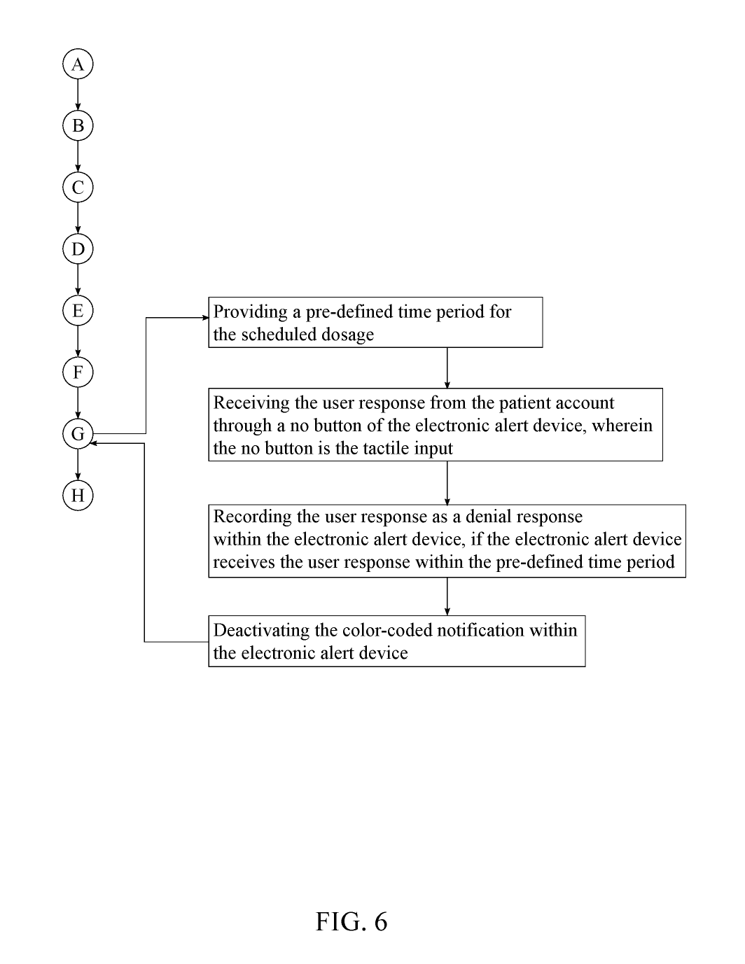

In reference to FIG. 1 and FIG. 6, when scheduled dosage is not taken by the patient account, the patient account is supposed to push the no button to disable the color-coded notification. More specifically, when the chipset detects the no button activation as the user response within the electronic alert device, the chipset records the user response as a denial response within the present invention if the denial response is received within the pre-defined time period. The chipset then deactivates the color-coded notification within the electronic alert device. Additionally, the chipset also timestamps an event time and the denial response within the electronic alert device.

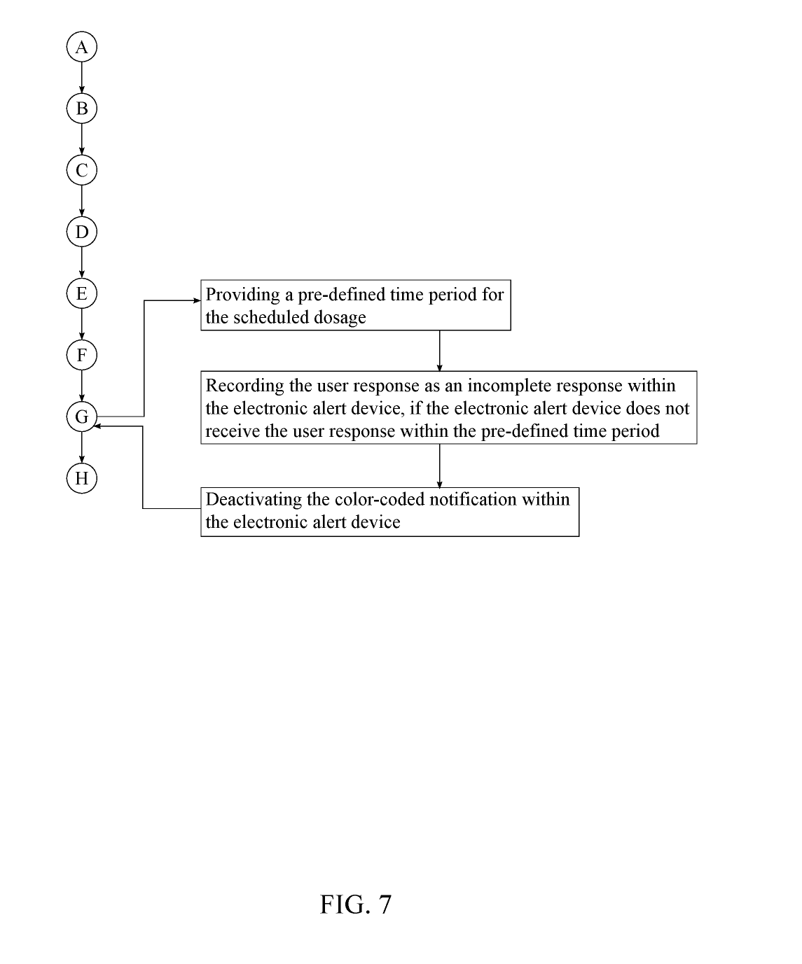

In reference to FIG. 1 and FIG. 7, when scheduled dosage is not taken by the patient account and the patient account does not push the yes button or the no button to disable the color-coded notification, the chipset detects that neither the yes button nor the no button is activated as the user response within the electronic alert device. The chipset then records the user response as an incomplete response within the present invention if the user response is not received within the pre-defined time period. The chipset then deactivates the color-coded notification within the electronic alert device after the pre-defined time period. Additionally, the chipset also timestamps an event time and the incomplete response within the electronic alert device.

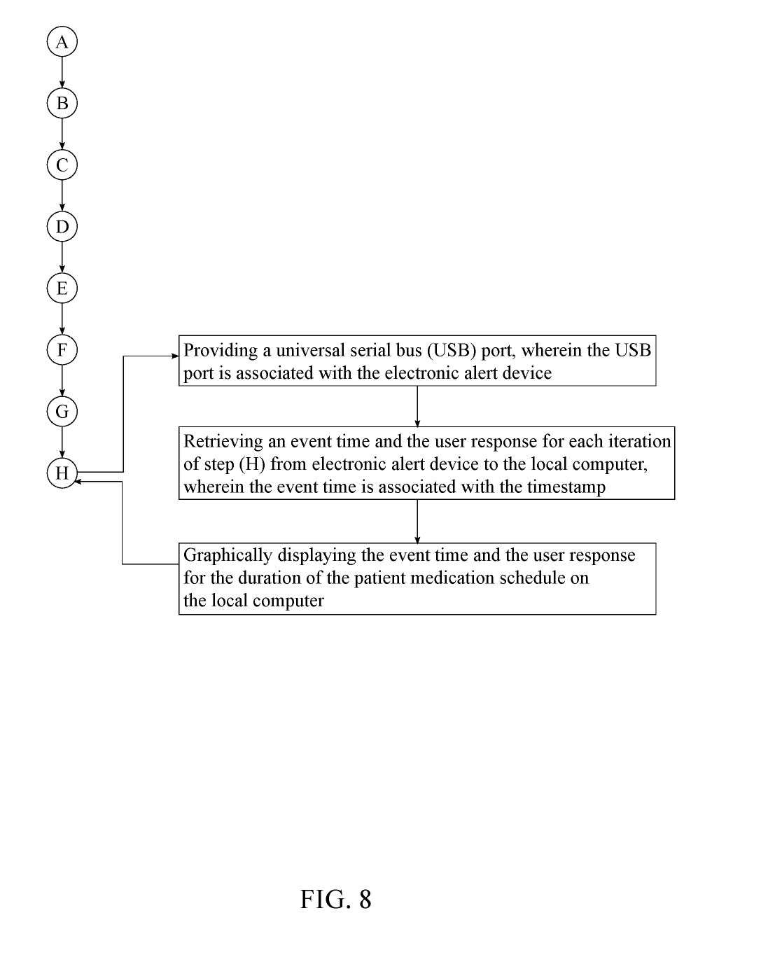

The aforementioned process explains a single event that illustrates the overall process of the present invention. However, reiteration of the aforementioned process for the duration of the patient medication schedule, which can be weeks, months, or years, creates a plurality of events within the present invention. When it is time for the next visit to the care provider account, the patient account presents the electronic alert device to the care provider account. In reference to FIG. 1 and FIG. 8, the care provider account is able to retrieve the event time and the user response for each iteration of the plurality of events into the local computer through the USB port. The event time and the user response for each iteration are then graphically displayed as a graph for the duration of the patient medication schedule. The event time and the user response for each iteration are also formatted and exported to a patient portal and/or an electronic health records (EMR) system. As a result, the care provider account can use the retrieved data as a way of encouraging the patient account to comply and take the scheduled dosage. Additionally, because all data are uploaded to a database (e.g., EMR or remote server), the data can be used to improve and design care for an entire patient population.

A continuous relationship between the patient account and the care provider account is critical for effectively improving compliance between the two parties. As a result, the present invention is able to establish an accountability relationship between the patient account and the care provider account. The retrieved data helps the patient account to understand what must be done for their treatment to be effective (and whether or not they fall short of that mark). By analyzing the retrieved data over time, the care provider account also able to better understand the patient account behavior and thereby be better equipped to prescribe future medical treatments by tailoring it for the corresponding patient account.

Although the invention has been explained in relation to its preferred embodiment, it is to be understood that many other possible modifications and variations can be made without departing from the spirit and scope of the invention as hereinafter claimed.

What is claimed is:

1. A method of improving patient medication compliance, the method comprises the steps of:
(A) providing a patient account and a care provider account, wherein the patient account is associated with a patient profile;
(B) providing an electronic alert device, wherein the electronic alert device is managed by the care provider account and is associated with at least one prescribed medication of the patient profile;
(C) assigning a color-coded notification to the prescribed medication through a local computer, wherein the care provider account accesses the patient profile through the local computer;
(D) generating and uploading a patient medication schedule for the electronic alert device from the local computer, wherein the prescribed medication and the color-coded notification are associated with the patient medication schedule;
(E) generating and visually emitting the color-coded notification from the electronic alert device for a scheduled dosage of the prescribed medication, wherein the scheduled dosage is derived from the patient medication schedule;
(F) prompting the patient account to confirm or deny intake of the scheduled dosage through a tactile input of the electronic alert device;
(G) timestamping and recording a user response within the electronic alert device in order to disable the color-coded notification; and
(H) reiterating steps (E) through (G) for the duration of the patient medication schedule.

2. The method of improving patient medication compliance, the method as claimed in claim 1 comprises the steps of:
providing an audible notification to the prescribed medication;
assigning the audible notification to the prescribed medication through the local computer during step (C); and
generating and audibly emitting the audible notification from the electronic alert device for the scheduled dosage during step (E).

3. The method of improving patient medication compliance, the method as claimed in claim 1 comprises the steps of:
providing the patient medication schedule with at least one daily dosage time;
identifying the daily dosage time within the electronic alert device in order generate the color-coded notification; and
repeatedly emitting the color-coded notification through a light emitting diode (LED) of the electronic alert device at the daily dosage time for the scheduled dosage.

4. The method of improving patient medication compliance, the method as claimed in claim 1 comprises the steps of:
providing a pre-defined time period for the scheduled dosage;
receiving the user response from the patient account through a yes button of the electronic alert device, wherein the yes button is the tactile input;
recording the user response as a confirmation response within the electronic alert device, if the electronic alert device receives the user response within the pre-defined time period; and
deactivating the color-coded notification within the electronic alert device.

5. The method of improving patient medication compliance, the method as claimed in claim 1 comprises the steps of:
providing a pre-defined time period for the scheduled dosage;
receiving the user response from the patient account through a no button of the electronic alert device, wherein the no button is the tactile input;
recording the user response as a denial response within the electronic alert device,
if the electronic alert device receives the user response within the pre-defined time period; and
deactivating the color-coded notification within the electronic alert device.

6. The method of improving patient medication compliance, the method as claimed in claim 1 comprises the steps of:
providing a pre-defined time period for the scheduled dosage;
recording the user response as an incomplete response within the electronic alert device, if the electronic alert device does not receive the user response within the pre-defined time period; and
deactivating the color-coded notification within the electronic alert device.

7. The method of improving patient medication compliance, the method as claimed in claim 1 comprises the steps of:
providing a universal serial bus (USB) port, wherein the USB port is associated with the electronic alert device;
retrieving an event time and the user response for each iteration of step (H) from electronic alert device to the local computer, wherein the event time is associated with the timestamp; and
graphically displaying the event time and the user response for the duration of the patient medication schedule on the local computer.
